(19) United States
(12) Patent Application Publication
(10) Pub. No.: US 2008/0228626 A1
(43) Pub. Date: Sep. 18, 2008

(54) Auctions For Health Care Providers

(76) Inventor: Brett D. Frankenberg, Carlsbad, CA (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 12/016,538

(22) Filed: Jan. 18, 2008

Related U.S. Application Data
(60) Provisional application No. 60/881,281, filed on Jan. 18, 2007.

(51) Int. Cl. G06Q 40/00

(52) U.S. Cl. 705/37

(57) ABSTRACT

In one aspect, there is provided a computer-implemented method. The method may include providing user interfaces to enable an auction between a provider of health care and an employer. A first auction may be initiated by a user interface associated with a provider of health care. The first auction may be initiated when profile information of the provider is received. A second auction may be initiated by a user interface associated with the employer, when the employer seeks a placement of the provider. The user interface associated with the employer may be used to make bids on at least one of the first auction and the second auction. Related systems, apparatus, methods, and/or articles are also described.

### CROSS REFERENCE TO RELATED APPLICATION

This application claims the benefit under 35 U.S.C. §119(e) of a provisional application U.S. Ser. No. 60/881,281, entitled “AUCTIONS FOR HEALTH CARE PROVIDERS,” filed Jan. 18, 2007 (Attorney Docket No. 35548-501-PRO), which is incorporated by reference herein.

### FIELD

The subject matter described herein relates to auctions.

### BACKGROUND

Healthcare providers, such as doctors and nurses, are a valuable resource. At present, when an employer, such as a hospital, seeks to fill a position for a healthcare provider, the entire process can take months. Moreover, the process is laborious and is further complicated by nursing, allied health and physician supply shortages. Not only is it difficult to find a qualified candidate for a position, but the hiring process itself requires background checks, drug screening, reference checks, and the like. As a consequence, human resources staff tasked to fill the position may be burdened with the complex, time-consuming hiring process.

### SUMMARY

In one aspect, there is provided a computer-implemented method. The method may include providing user interfaces to enable an auction between a provider of health care and an employer. A first auction may be initiated by a user interface associated with a provider of health care. The first auction may be initiated when profile information of the provider is received. A second auction may be initiated by a user interface associated with the employer, when the employer seeks a placement of the provider. The user interface associated with the employer may be used to make bids on at least one of the first auction and the second auction.

In another aspect, there is provided a computer-implemented method. The method includes receiving a first indication of a first auction initiated by a first user interface associated with a provider of health care; receiving a second indication of a second auction initiated by a second user interface associated with an employer, when the employer seeks a placement (e.g., permanent, temporary, or traveling) of the provider; and receiving one or more bids on at least one of the first auction and the second auction. In some implementations, the received one or more bids may enable the provider to choose the bid that they want. Moreover, any resulting interviews including the provider may be in-person (e.g., face-to-face with a representative of the employer) or virtual (e.g., using a computer over the Internet).

Articles are also described that comprise a tangibly embodied machine-readable medium embodying instructions that, when performed, cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

In the drawings,

FIG. 1A depicts a process flow diagram for providing profile information for a provider of health care;

FIG. 1B depicts a block diagram of a system for enabling an auction between the provider of health care and the employer;

FIGS. 2-11 depict various pages presented at a user interface of a provider of healthcare;

FIGS. 12A-12B depict a process flow diagram for making bids for a provider of health care;

FIGS. 13-21B depict various pages presented at a user interface of an employer; and

FIGS. 22-39 depict various pages presented at a user interface of an administrator of the auction.

### DETAILED DESCRIPTION

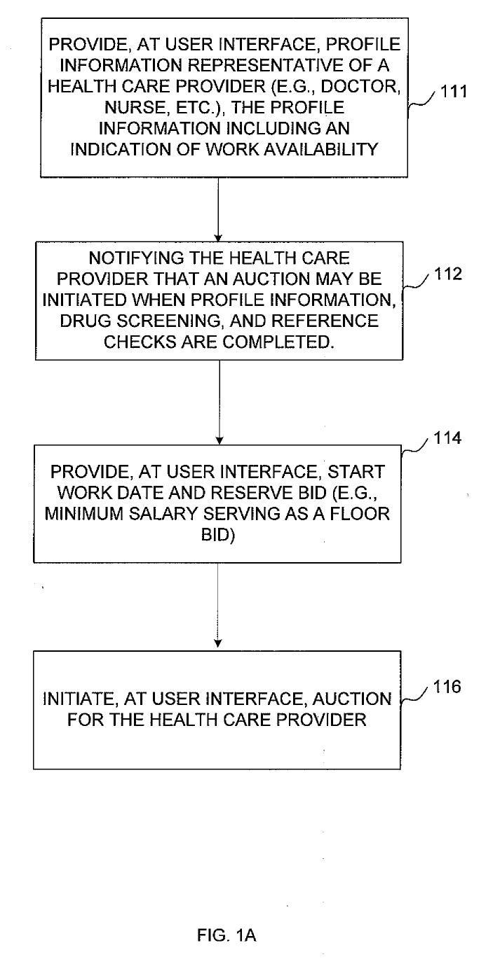

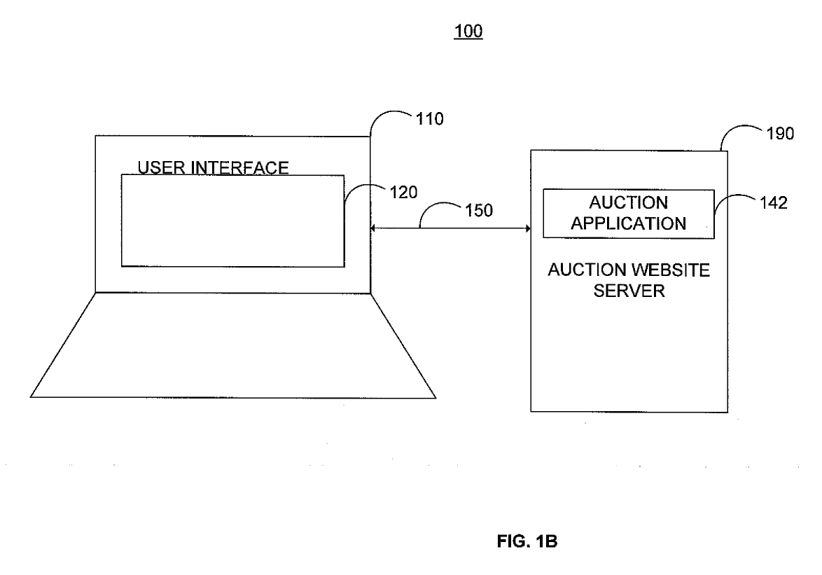

FIG. 1A depicts a method for providing a user interface that enables health care providers, such as doctors, nurses, chiropractors, therapists, medical technicians, and the like, to auction their services to employers, such as hospitals, clinics, and the like. FIG. 1B depicts a system 100 for enabling the auctions. Referring to FIG. 1B, a computer 110 includes a user interface 120 (e.g., a browser). The computer 110 is coupled through a communication link 150 to a server hosting a website 190. The website may include an auction application 142 that enables health care providers (also referred to as providers and/or healthcare professionals and/or professionals) to auction their services to employers. Moreover, the auction application 142 may provide pages (also referred to as web pages) to user interfaces to enable the auctions.

Although FIG. 1B depicts only a single computer 110, a single user interface 120, and a single website 190, a plurality of those elements may be implemented as well. For example, an employer may use computer 110 and a user interface 120 to interact with website 190 during an auction, while a provider may use a similar computer and user interface to interact with website 190 during the auction. Moreover, the user interface 120 may be implemented as any interface that enables a user to interact with website 190 and auction application 142. For example, the user interface 120 may be implemented as a browser, such as Netscape Navigator or the like, or any other type of graphical user interface.

Moreover, communication link 150 may be implemented as any type of communications mechanism and may include, alone or in any suitable combination, a telephony-based network, a local area network (LAN), a wide area network (WAN), a dedicated intranet, wireless LAN, the Internet, an intranet, a wireless network, a bus, or any other communication mechanisms. Further, any suitable combination of wired and/or wireless components and systems may provide communication link 150. Moreover, communication link 150 may be embodied using bi-directional, unidirectional, or dedicated communication links. Communication link 150 may also implement standard transmission protocols, such as Transmission Control Protocol/Internet Protocol (TCP/IP), Hyper Text Transfer Protocol (HTTP), SOAP, RPC, or other protocols.

The server of website 190 may include one or more processors, such as computers, to interface with other computers, such as computer 110, and/or programs, such as user interface 120. The auction application 142 may be implemented as a program or group of programs.

Referring again to FIG. 1A, at 111, a user, such as the health care provider (also referred to as “provider” or “healthcare professional” or “professional”), may provide at user interface 120 profile information. The profile information may include one or more of the following: discipline or licensure of the provider, specialty, work setting or environment, state license information, areas in which employment is sought, a list of references, drug testing information, and a background check. The profile information may further include one or more of the following: name, address, phone number, social security number, citizenship information, relocation information, preferred work area(s), preferred clinical setting, shift preferences, preferred days of week, type of employment (e.g., permanent, temporary, and/or traveling), experience, certifications, and any other information that may be relevant to employment. The profile information may be stored at a website 190 hosting the auction application (also referred to herein as the “auction website”).

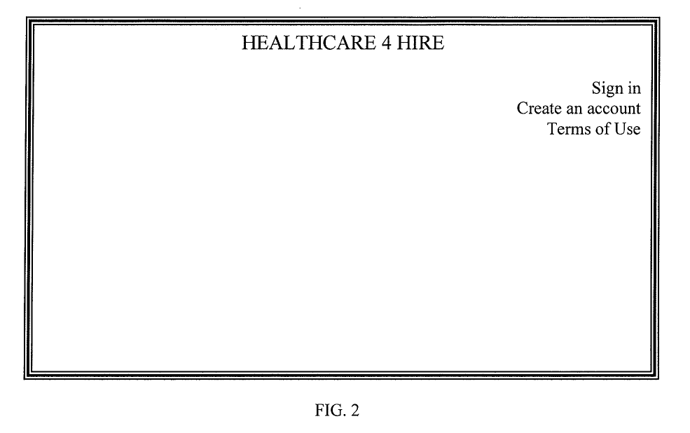

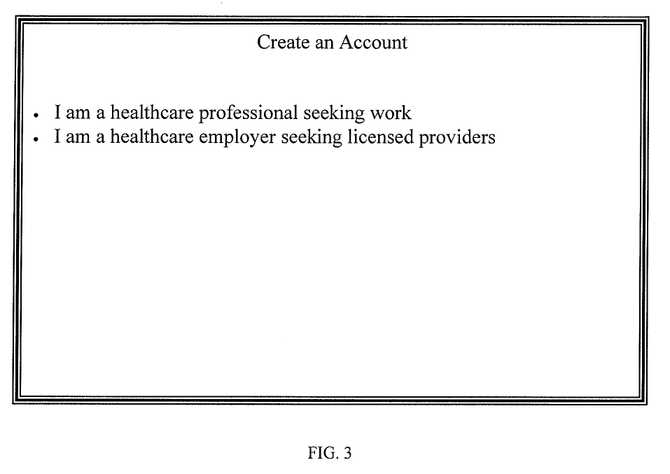

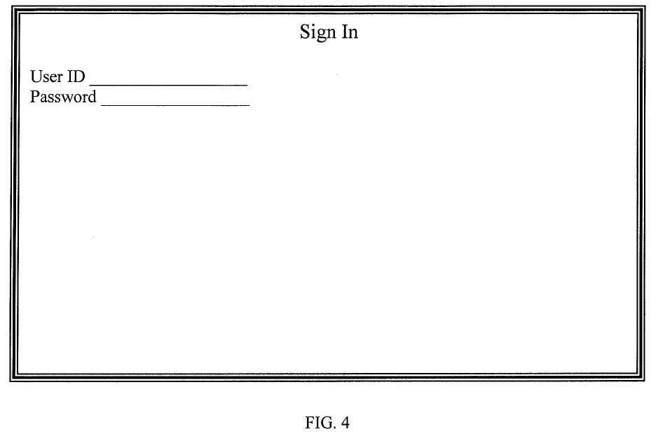

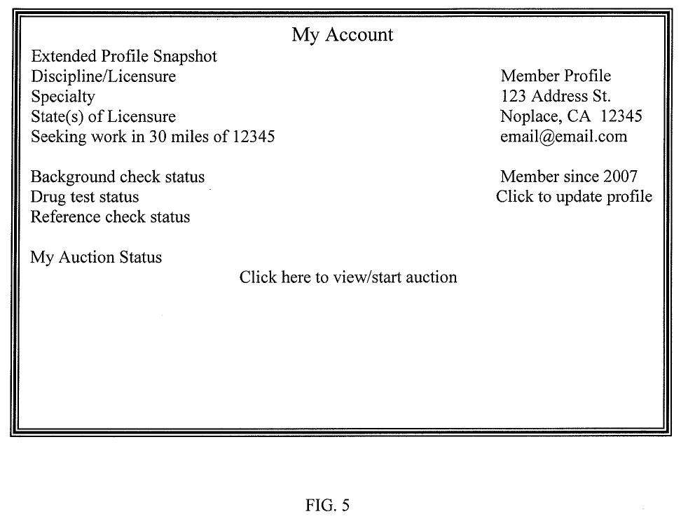

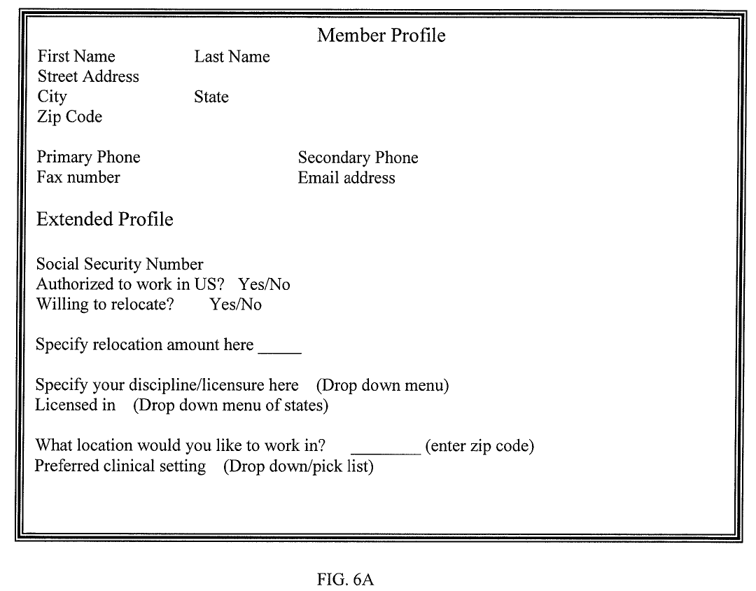

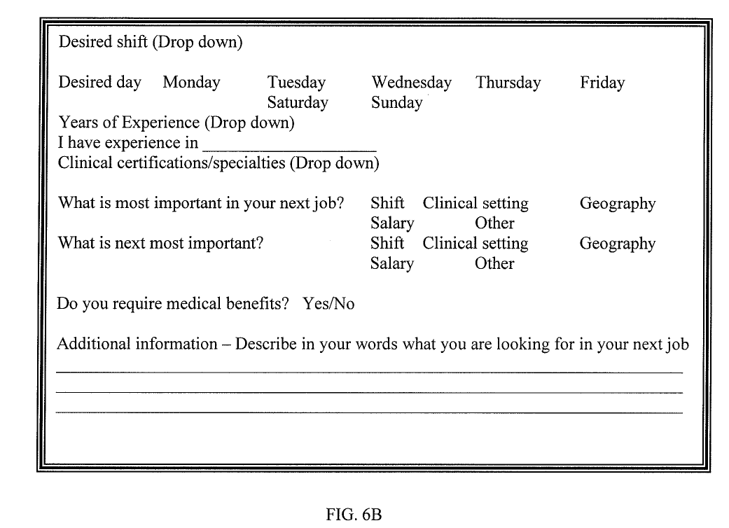

Before the user (i.e., the provider) provides the profile information at 111, the provider may be prompted to create an account at auction website 190. FIGS. 2-3 depict example pages provided to user interface 120 from auction website 190. The pages of FIGS. 2-3 are provided to user interface 120 to enable the provider to create an account. FIG. 4 depicts a page presented to the provider at user interface 120 when the provider has already created an account at auction website 190. FIG. 5 depicts a page presented to user interface 120 that summarizes the account of the provider. FIGS. 6A-6B depict pages presented at user interface 120 that enable the provider to provide profile information.

Referring again to FIG. 1A, at 112, when the profile information has been provided to auction website 190 and the provider has completed a drug screening, a background check, and a check of the any references, the provider may be notified by auction website 190 that an auction may be initiated. At 114, the provider may provide, at user interface 120, additional information, such as a minimum salary and a start date, before initiating the auction. At 116, the provider initiates, at user interface 120, the auction. In some implementations, the provider initiates an auction for temporary placement of the provider's services, while in other implementations, the provider initiates an auction for permanent employment. The auction thus enables employers to bid on the services of the provider.

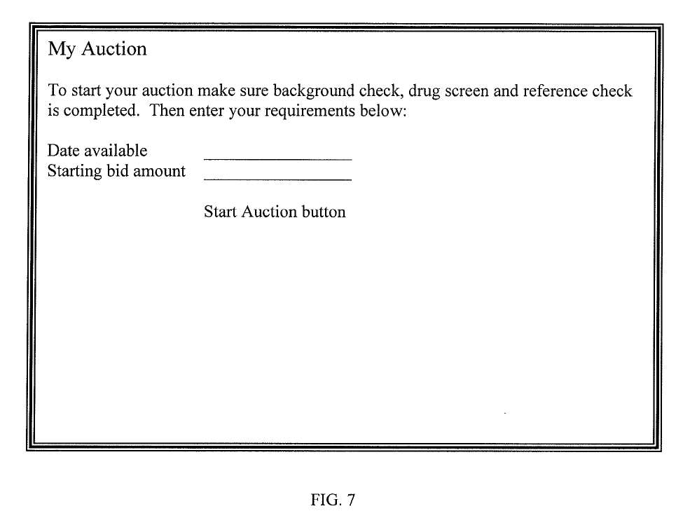

FIG. 7 depicts a page provided by auction website 190 to the provider's user interface 120. The page of FIG. 7 enables the user of user interface 120 to provide a minimum salary and a start date as well as initiate the auction by, for example, selecting “Start Auction.”

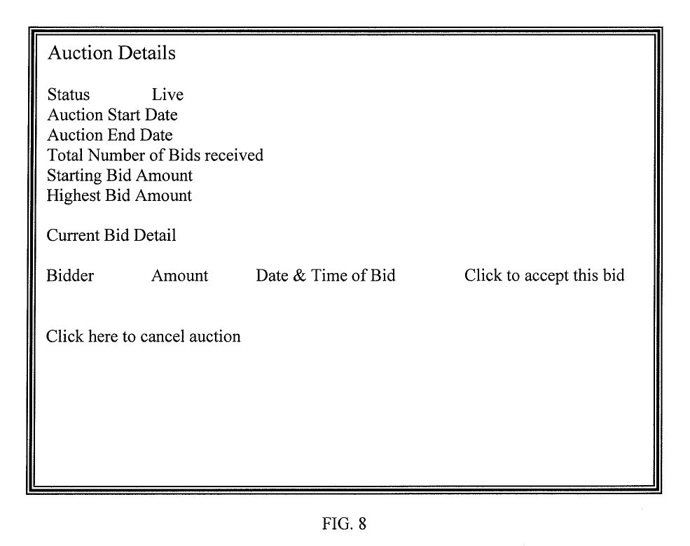

FIG. 8 depicts summary information concerning a provider's auction. The summary information may include one or more of the following: auction status, a begin date of an auction, a closing date of an auction, a total number of bids received, a starting (or opening) bid, and a highest bid. FIG. 8 depicts that the provider has three bids. The provider may select any (or none) of the bids within, for example, 72 hours of its being submitted. In some cases, the provider may select the highest bid, while in other cases the provider may select the lowest bid. In some cases, the auction website 190 may automatically select the highest bidder when the auction closes. However, the provider has the option to accept or decline a bid even the highest bid but only after an interview between the employer and provider.

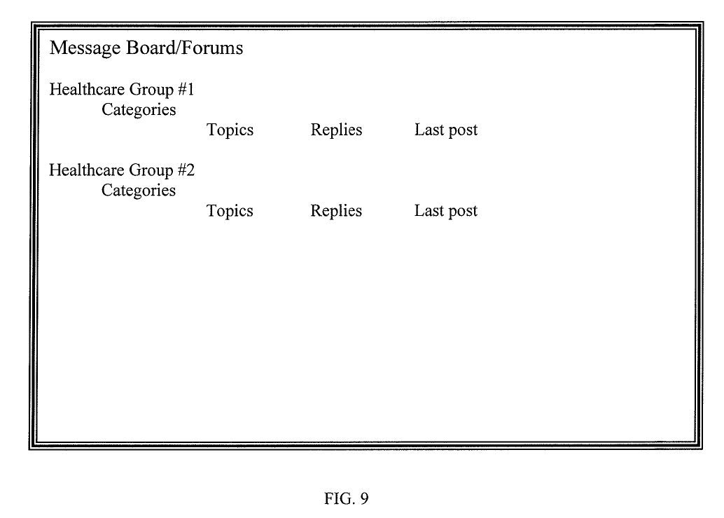

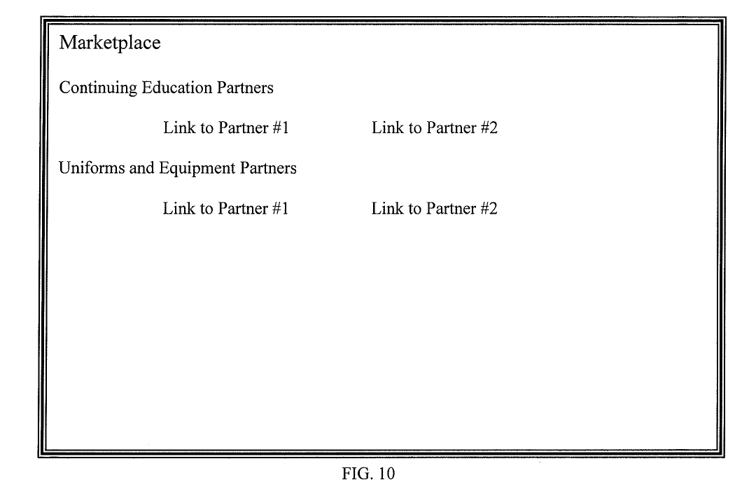

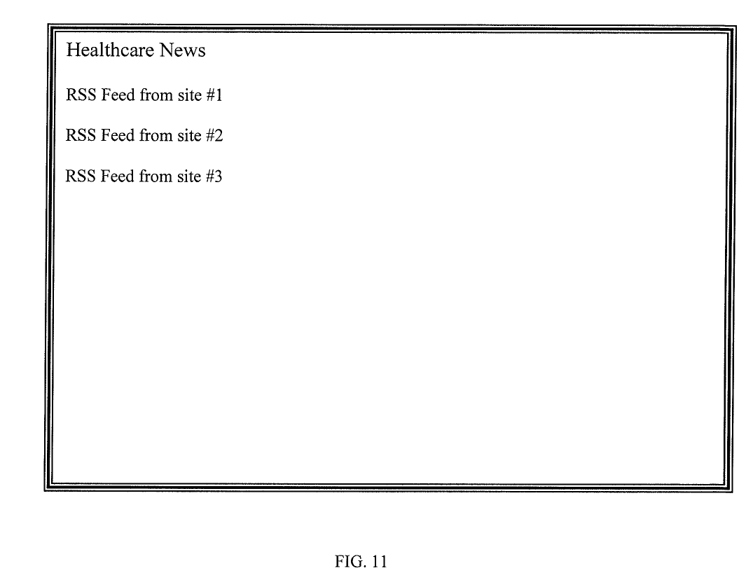

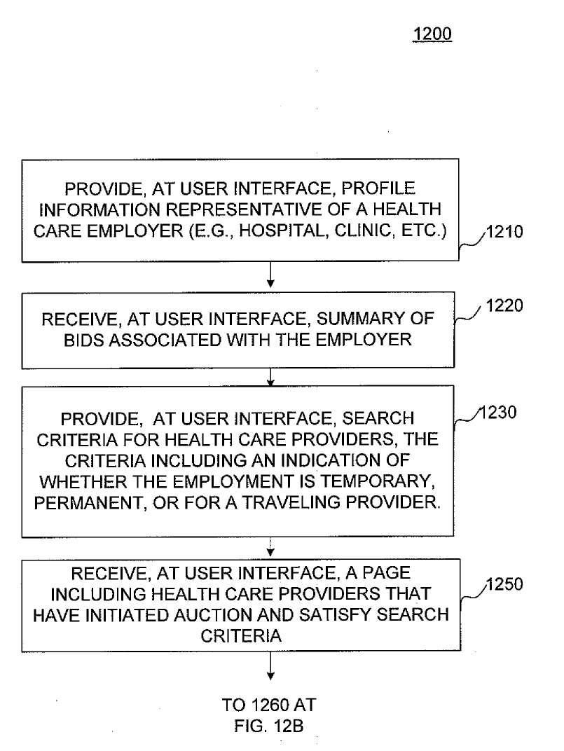

FIGS. 9-11 depict additional services provided by auction application 142 and website 190. For example, FIG. 9 depicts a message board presented at user interface 120 that allows providers to post messages on a variety of health care related topics. FIG. 10 depicts a marketplace that allows services to be offered to providers. For example, a 10% discount may be offered to a provider when purchasing clothing (e.g., scrubs), continuing education courses, or other educational material. FIG. 11 depicts health care related news presented to providers.

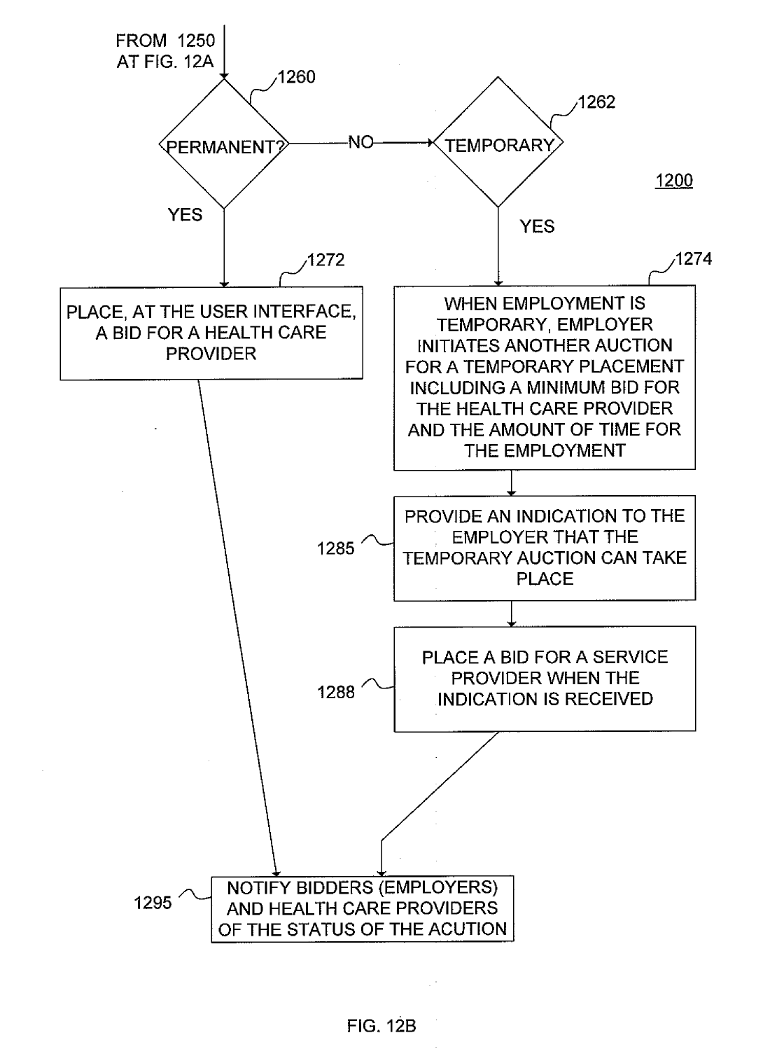

FIGS. 12A-12B depict a method 1200 for enabling employers to bid in auctions for providers. The employers may access auction website 190 including auction application 142 using a computer and a user interface similar to those described above with respect to FIG. 1.

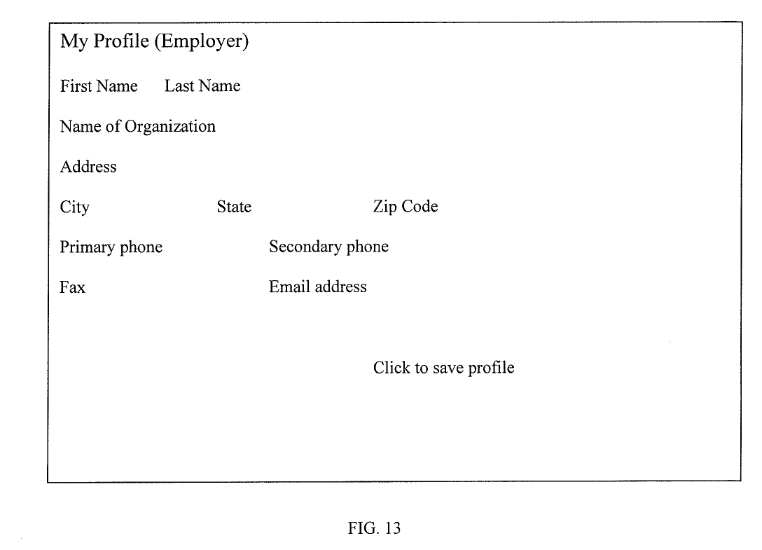

At 1210, an employer at a user interface provides profile information to auction website 190. The profile information may include one or more of the following: name, address, and phone number of the employer, contact person for the employer, clinical setting, and the like and asks the registrant to confirm that they have the authority to commit funds on behalf of the employer. FIG. 13 depicts an example of a page provided by auction website 190 to the user interface of the employer, so that the employer can provide profile information. Once a profile is provided, the employer's account is created at auction website 190, so that the employer can search for and bid for providers.

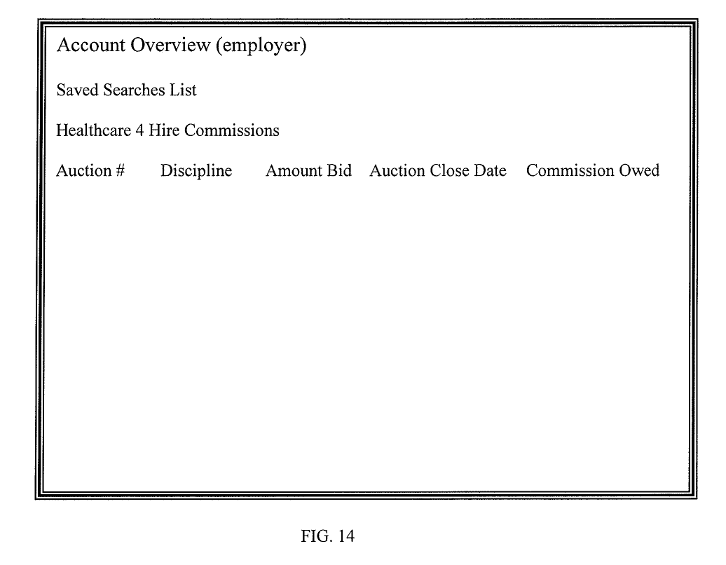

FIG. 14 depicts a summary of an employer's account after it is created at auction website 190. In the example depicted in FIG. 14, the employer has won two auctions, and must pay auction website 190 $5000 for each of the auctions.

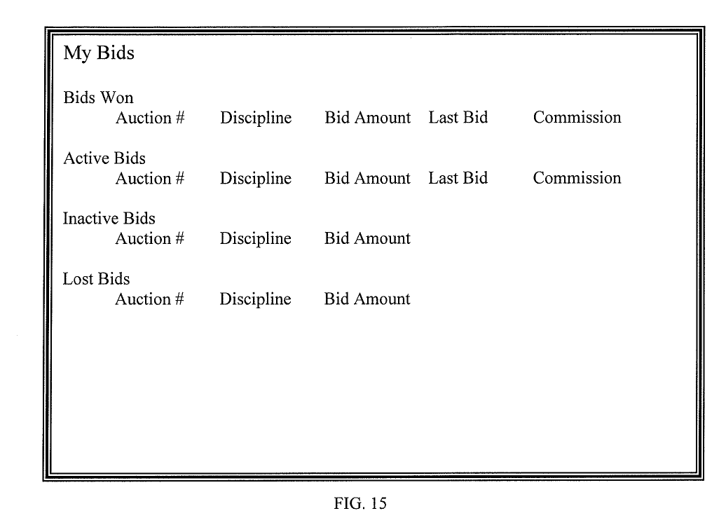

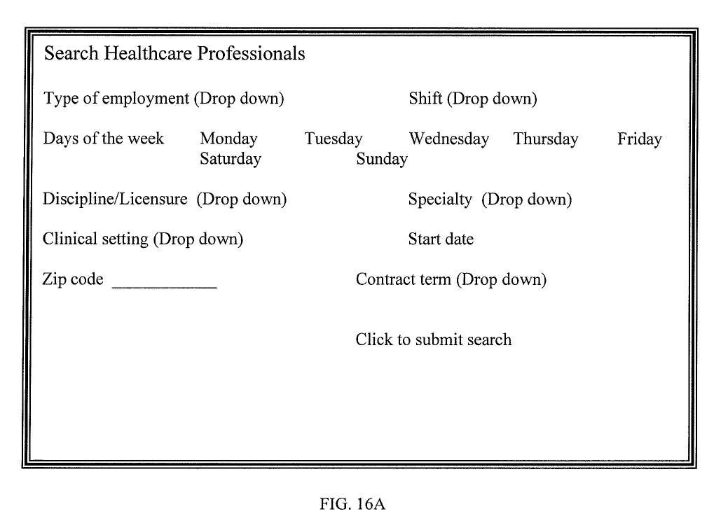

At 1220, the employer may receive at the user interface a summary of bids. FIG. 15 depicts an example of the bid summary information.

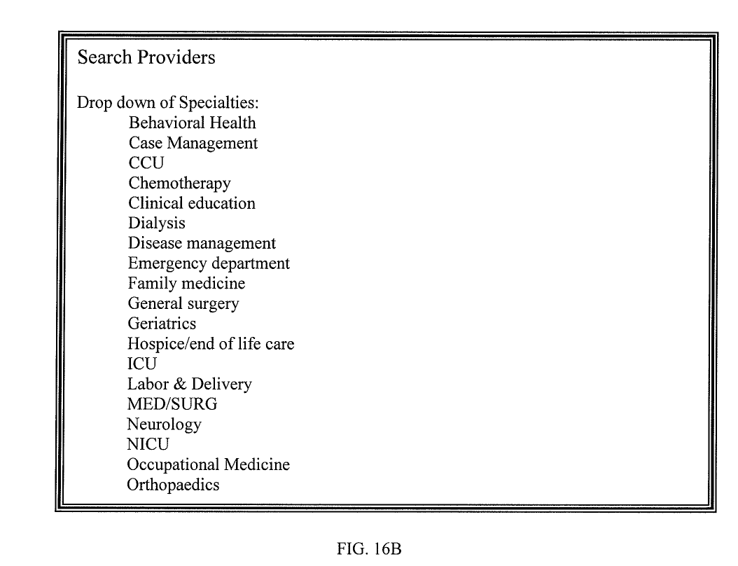

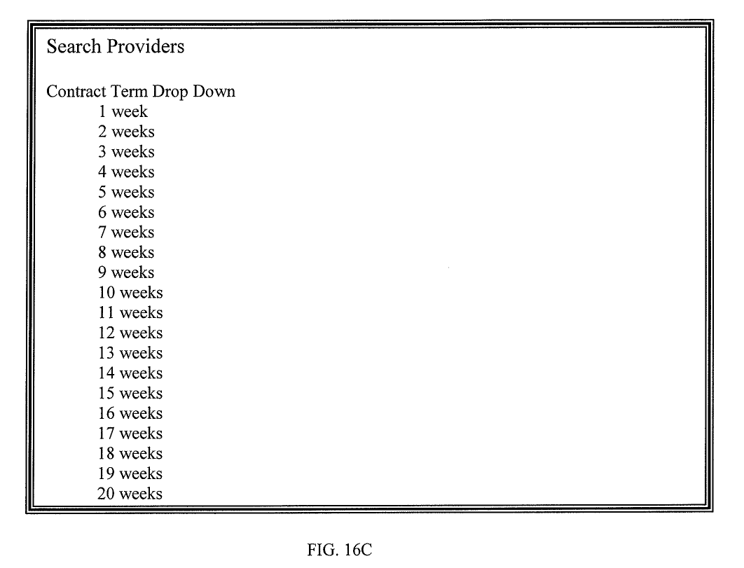

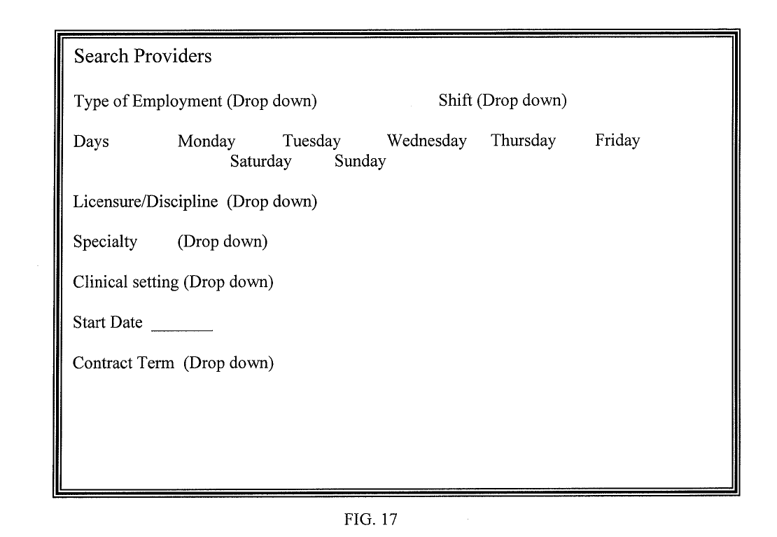

At 1230, the employer may provide, using the user interface, search criteria to identify potential providers for bidding. For example, the employer may provide one or more of the following as search criteria: type of employment (e.g., temporary, travel, or permanent), days of week, licensure or discipline (e.g., MD, DO, etc.), specialty, clinical setting (e.g., hospital, clinic, private practice, etc.), provider's start date, location of employer, and contract term. FIGS. 16A, 16B, 16C, and 17 depict pages provided by auction website 190 to the user interface of the employer, so that the employer can provide search criteria to identify a provider. FIG. 16A depicts a page provided by the auction website for a permanent auction. FIG. 16B depicts a page provided by the auction website including a pick list of specialties from which an employer can identify a provider with the “picked” specialty. FIG. 16C depicts a page provided by the auction website including a pick list of contract terms from which an employer can identify a provider with the “picked” contract term.

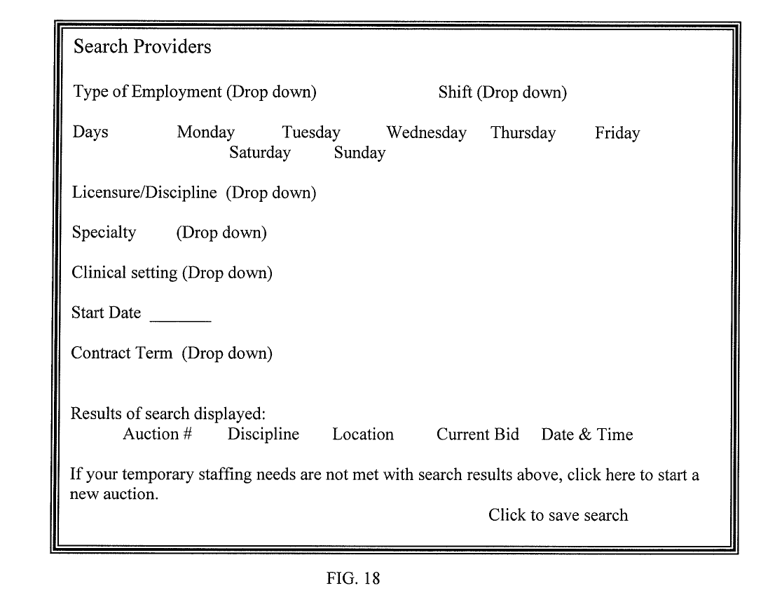

At 1250, the employer may receive a page including the provider demographics that have initiated an auction and that have satisfied one or more of the search criteria entered by the employer at 1230. FIG. 18 depicts a page received from auction website 190 by the user interface of the employer. The page of FIG. 18 enables the employer to view the providers that have initiated an auction and satisfy one or more of the search criteria previously entered at 1230.

At 1260 and 1272, when an employer identifies a provider that seeks permanent employment, the employer uses the user interface to place a bid (e.g., $75,000 per year,) for the provider.

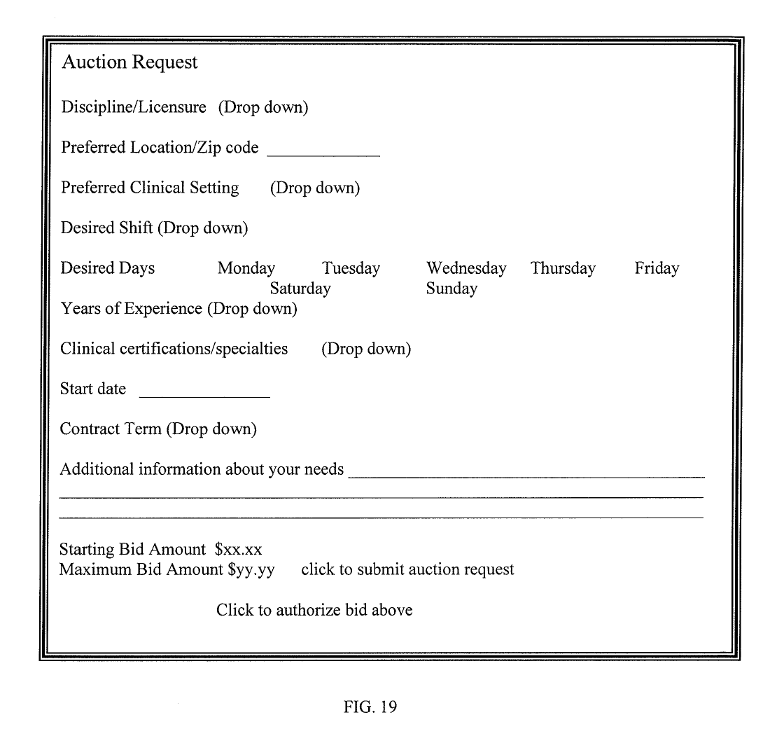

At 1262, when the employer seeks a temporary placement, a search using “temporary” as a criteria may, in some cases, not identify any providers. When that is the case, at 1274, the employer (rather than the provider) may be prompted by auction website 190 to initiate an auction. The employer-initiated auction requires the employer to commit to a minimum bid (e.g., a minimum term of employment and/or a minimum salary). For example, FIG. 19 depicts a page received by the user interface of the employer from the auction website. The page of FIG. 19 prompts the employer to provide an auction request for the temporary employment of a provider. Unlike permanent employment, a temporary employment is only for a specified term (e.g., days, weeks, or months).

At 1285, the auction website may provide an indication to the employer's user interface that the auction for the temporary placement of a healthcare provider may be initiated. For example, the auction website 190 may prescreen potential providers interested in temporary employment at the minimum term of employment and/or a minimum salary specified by the employer. At 1288, the employer places a bid (e.g., $60 per hour for 4 weeks) for one or more of the providers.

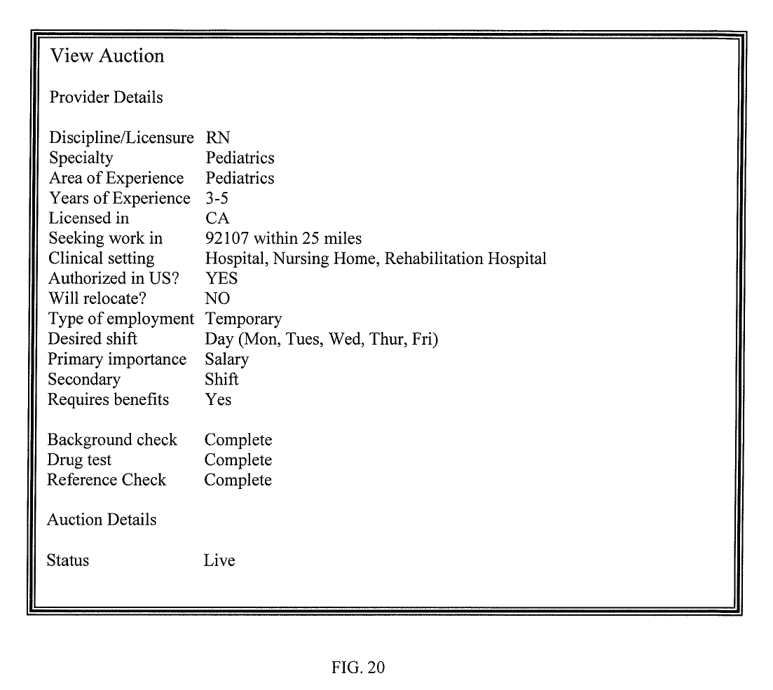

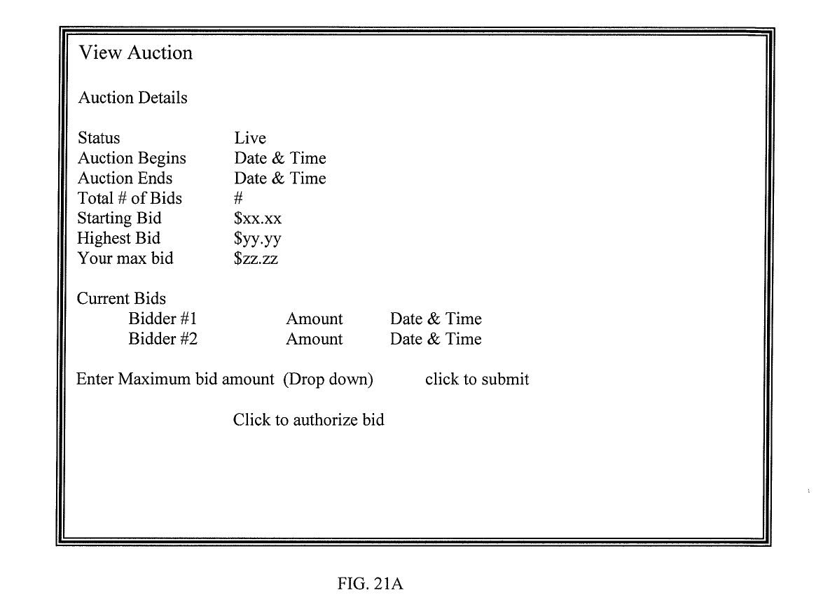

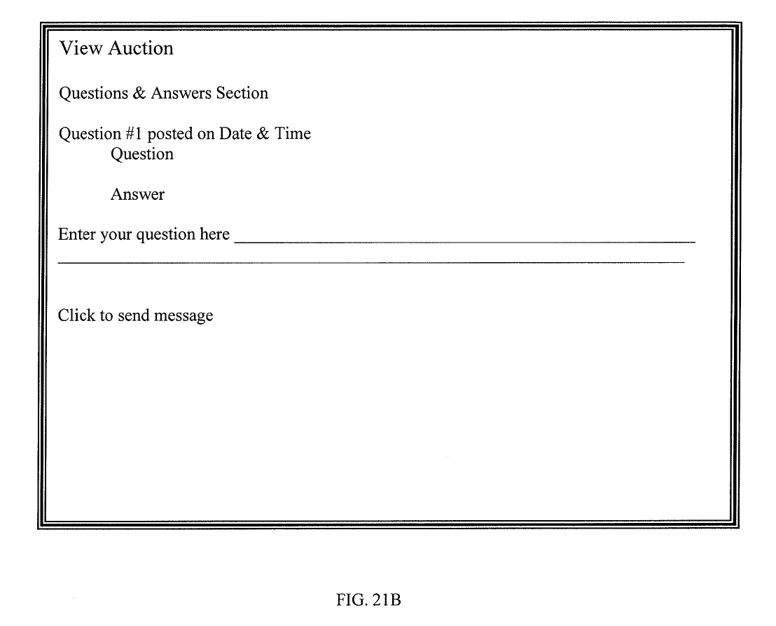

At 1295, employers (i.e., bidders) may be notified of the status of their bids. For example, a bid may be a winning bid, a losing bid, the lowest bid, the highest bid, or an expired bid. FIG. 20 depicts a page received from the auction website by the user interface of the employer. The page of FIG. 20 provides status information for a specific auction and the status of that auction. If the bidder wants status information for all their bids, the bidder may view My Bids (FIG. 15). FIG. 21A depicts the lower portion of the page of FIG. 20. The page of FIG. 21A depicts that an employer may enter a maximum bid amount that allows the auction website to increase the employers bid automatically if the employer is outbid by another employer.

In some implementations, auctions are run for 10 days. For permanent placement auctions, the provider has the ability to cancel the auction through interface 120, which negates the auction off the application 142 and the server 190. To discourage canceling of an auction, providers are allowed to cancel their auction twice within a 6-month period. If a provider cancels more than twice within a 6-month period, the provider may be barred from further auctions for 6 months. Auctions may close once the provider has accepted a bid, or when the 10-day auction period expires. At the close of an auction, each party to the auction (i.e., the employer and the provider) has 5 days to interview one another and either party may decide to opt out with no obligations to each other or to the party hosting the auction website server 190. If the employer and provider are in agreement, the party hosting the auction website server 190 sends an invoice to the employer for the commissions due. In some implementations, an auction may be closed sooner than 10 days by an employer invoking the “Hire Now” feature. The “Hire Now” feature allows an employer to pay a predetermined premium to close the auction early. For example, the employer that uses the “Hire Now” feature agrees to a premium of 25% above the reserve bid price in order to close the auction early. The “Hire Now” feature may be used during an auction for a temporary placement. In some cases, the temporary placement auctions may include similar aspects as described above.

For permanent placement auctions, an employer interested in learning more about a specific provider can use a communication feature in website 142 to ask the provider specific questions about their work experience and/or skills. The question is entered through the employer interface 120, routed through the server 190 to the provider. The provider sends answers back to the server 190, which are then edited and posted next to the original question. FIG. 21B depicts a question and answer section, which is made available to all employer bidders for viewing during an auction.

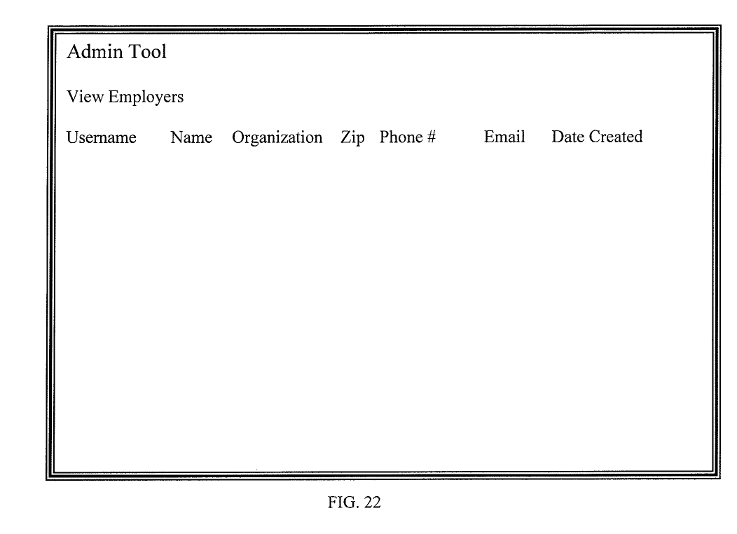

FIGS. 22-39 depict pages presented to a user interface. The pages of FIG. 22-39 enable a user, such as an employee of an entity hosting website 190 and application 142, to administer the auction as well as auction website 190

FIG. 22 depicts summary information listing all employers with accounts at auction website 190.

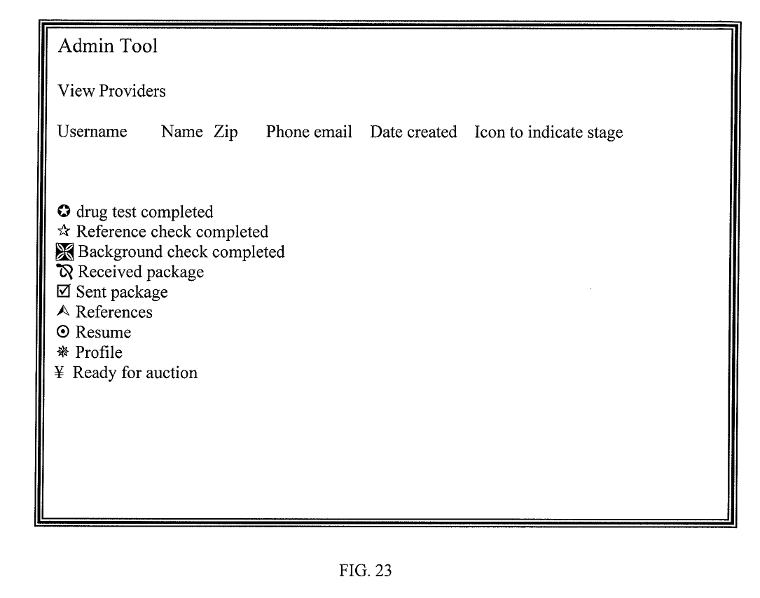

FIG. 23 depicts summary information listing all providers with accounts at auction website 190. FIG. 23 also shows icons (e.g., ready of auction, profile, resume, references, sent packages, received packages, background check, references check, and drug test) that provide a quick visual indication of the status of providers. The profile icon means that the provider has completed their extended profile, specifying the demographics of their desired job. There are two resume icons. The first one indicates that the provider has uploaded their resume to a website database at server 190, and the second indicates that the entity hosting the website 190 (e.g., employees of that entity) has edited the resume to remove identifying information of the provider from the document and has re-uploaded the resume for viewing by employers. The sent package icon indicates that a welcome packet has been sent by an employee of the entity hosting the website 190 to the provider. The received package icon means that the entity hosting the website 190 has received the packet back with all the requisite documents and information. There are two background check icons. The first background check icon means that the provider has faxed in the signed background check release form authorizing the entity hosting the website 190 to conduct the background screening. The second background check icon means that the entity hosting the website 190 has received the background screening information back from the vendor. There are two reference check icons. The first reference check icon means the provider has provided his or her reference information. The second reference check icon means that all references have been checked and uploaded to the provider's profile. The drug test icon means that the drug screening vendor has sent the entity hosting the website 190 the information specific to that provider's drug screen.

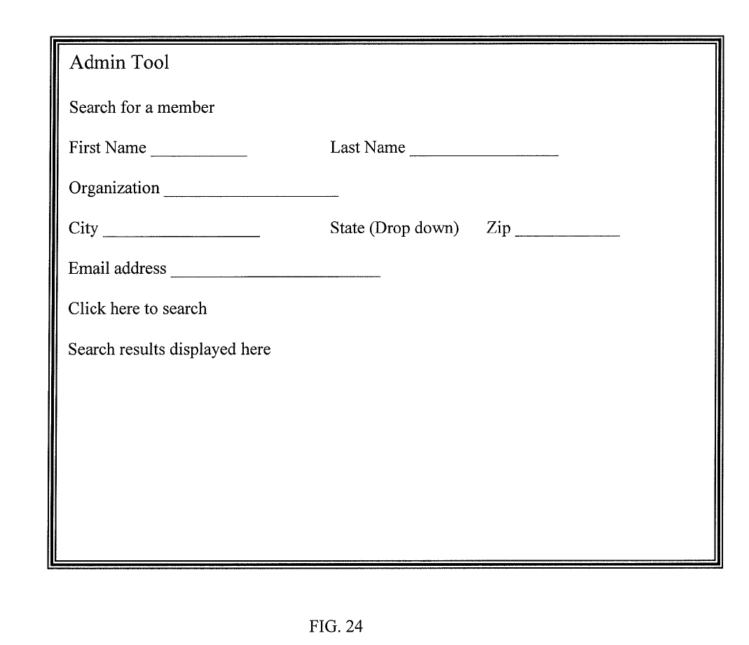

FIG. 24 depicts a page to search for a member (e.g., a provider or an employer).

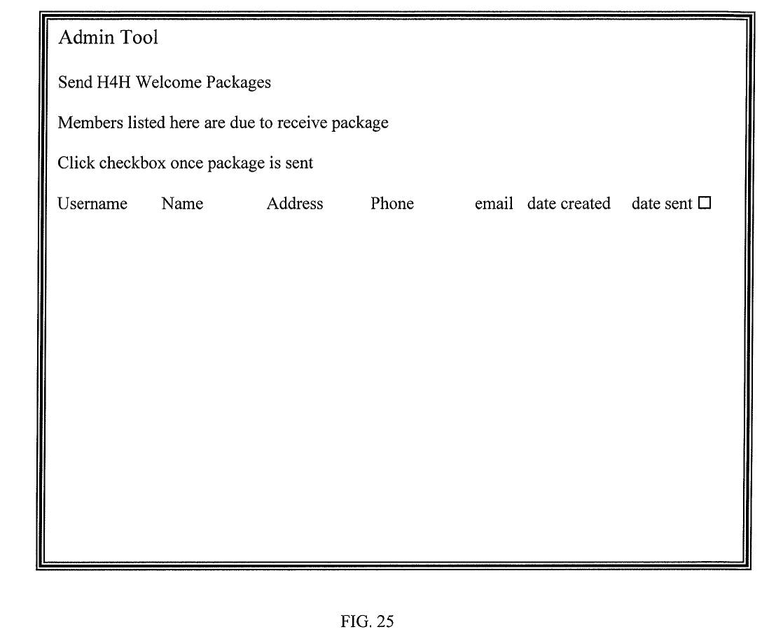

FIG. 25 depicts a page that shows whether a package has been sent to a provider. For example, the package may be sent after a user completes a profile and may include a user agreement between the provider and the entity hosting the website 190, the drug screen chain of custody form, a hard copy of the background check form, a postage paid return overnight envelope, a checklist of things to include in the return envelope, frequently asked questions, auction tips, and a welcome letter.

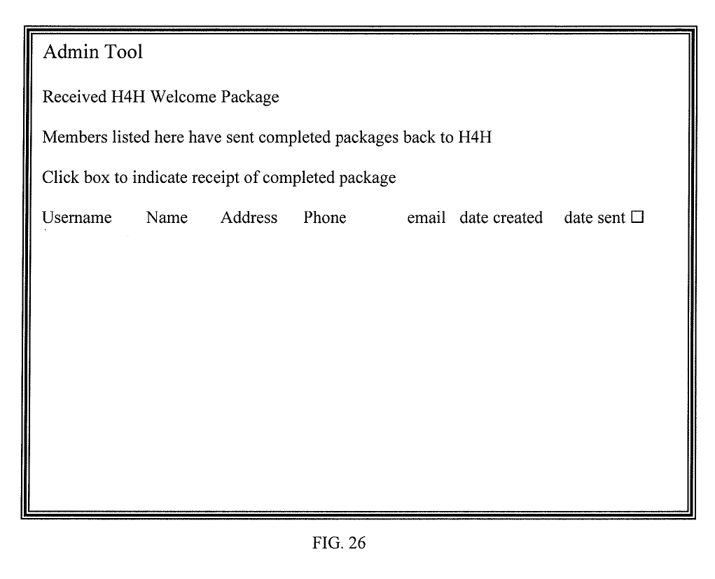

FIG. 26 depicts a page that shows whether a package sent to a provider has been completed and returned to auction web site 190.

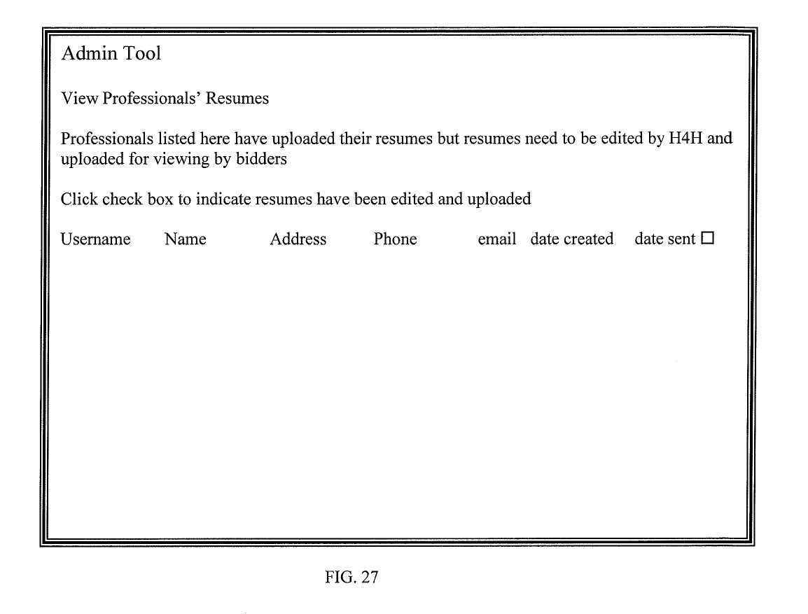

FIG. 27 depicts a page that shows whether resumes have been uploaded by providers

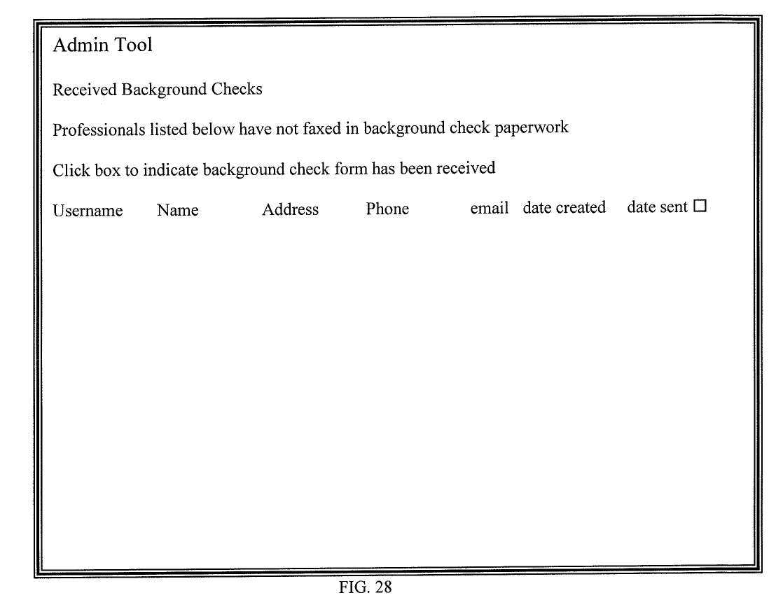

FIG. 28 depicts a page showing the status of background checks for providers. An example of a background check is a search by social security number of the federal felony database and county criminal record check.

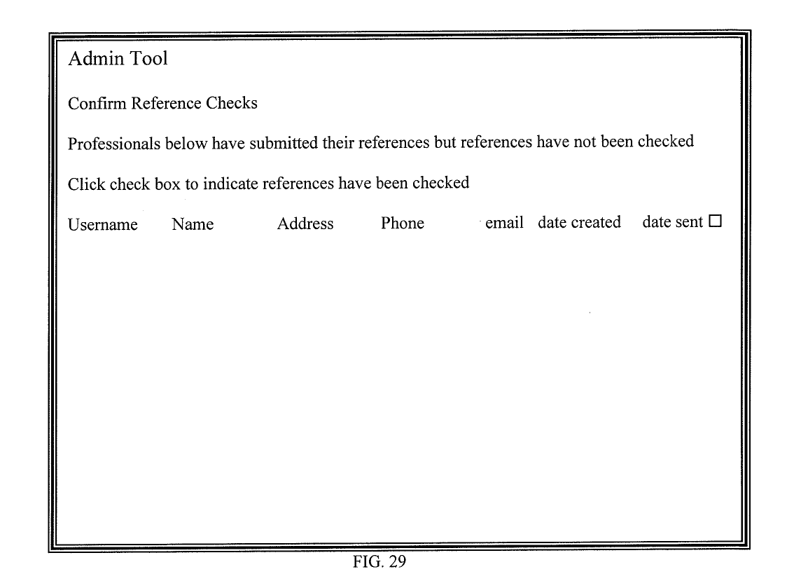

FIG. 29 depicts a page showing the status of reference checks for providers. For example, a provider may list a colleague or previous employer as a reference. Once the reference is checked (e.g., by calling the reference), the provider's references are “checked” by checking the box icon shown at FIG. 29.

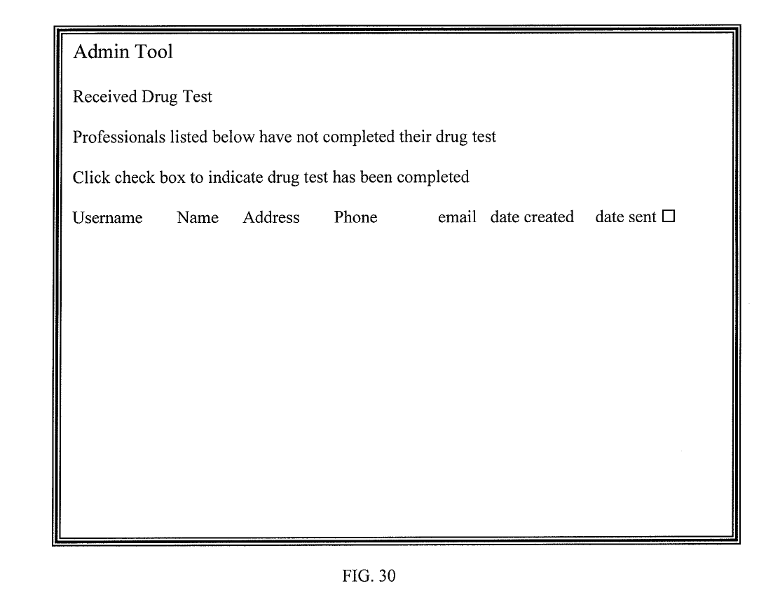

FIG. 30 depicts a page showing the status of drug screens for providers. For example, when a provider completes a drug screening, the provider's drug screen is considered complete and the box icon shown at FIG. 30 can be checked.

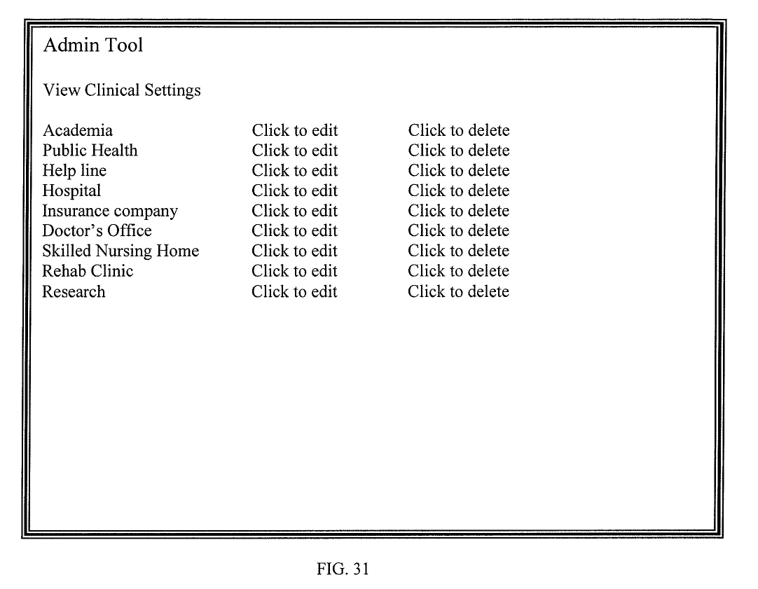

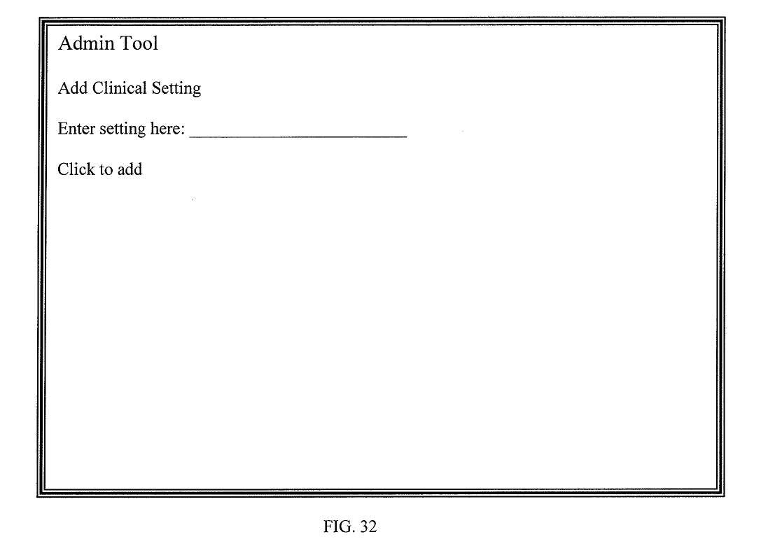

FIG. 31 depicts pages with various clinical settings. Once a clinical setting is added at FIG. 32, a provider may select one of these setting at 111 (FIG. 1A).

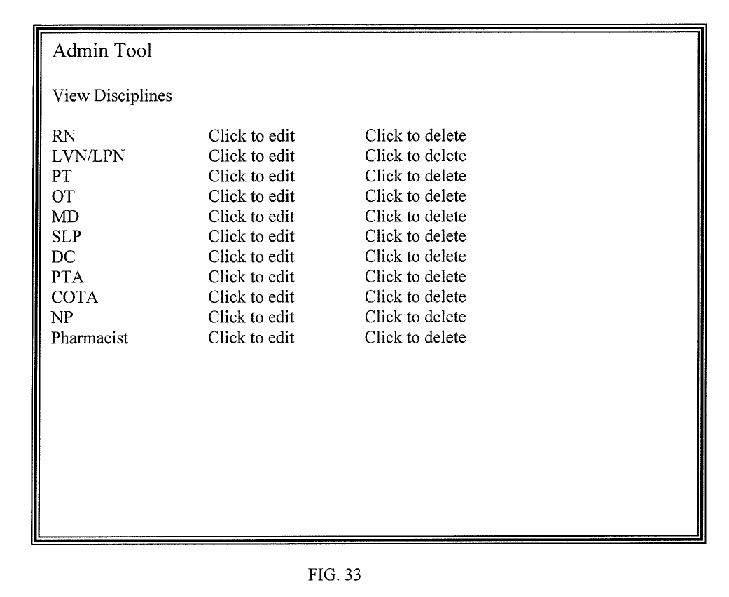

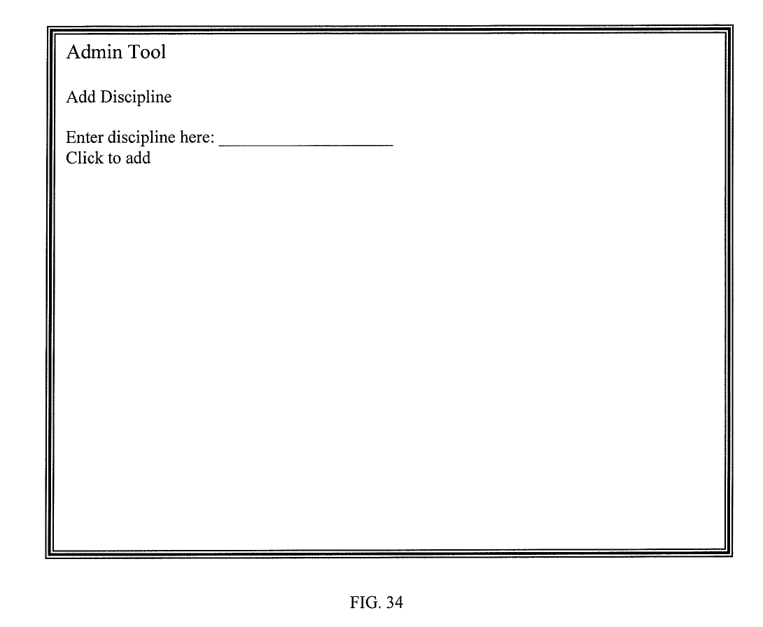

FIG. 33 depicts pages with various disciplines. Once a discipline is added at FIG. 34, a provider may select one of these disciplines at 111 (FIG. 1A).

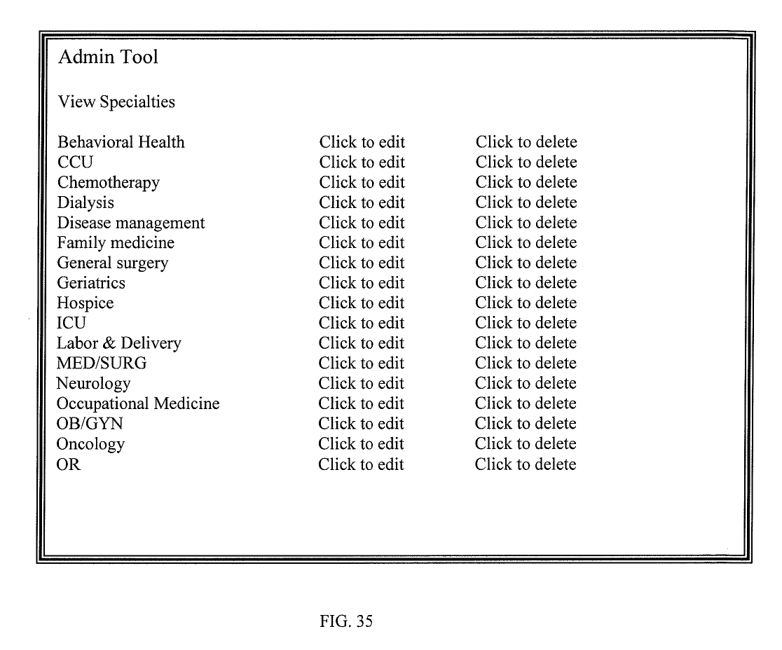

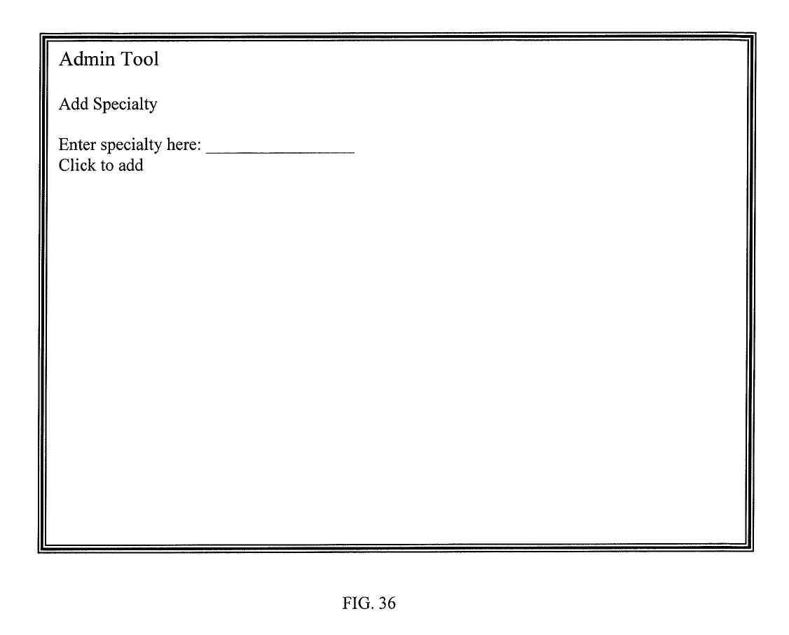

FIG. 35 depicts pages with various specialties. Once a specialties is added at FIG. 36, a provider may select one of these specialties at 111 (FIG. 1A).

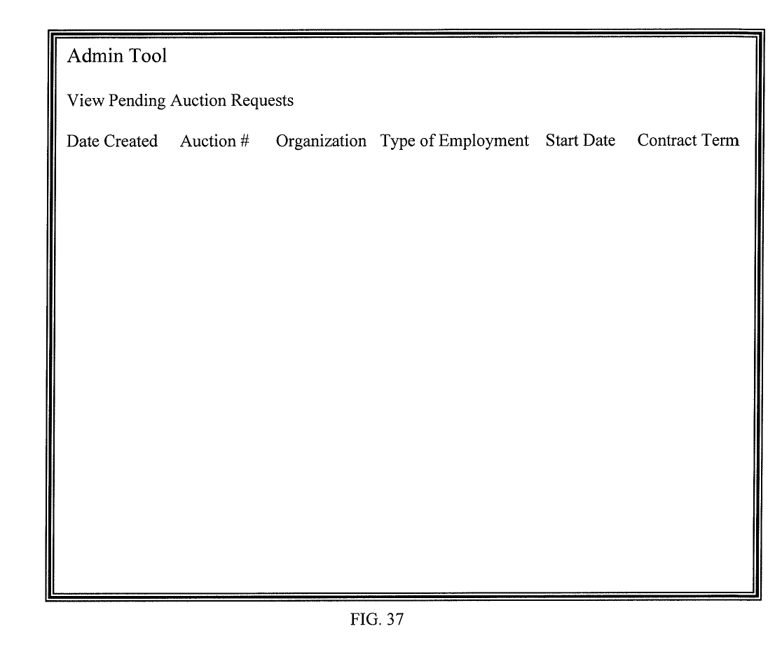

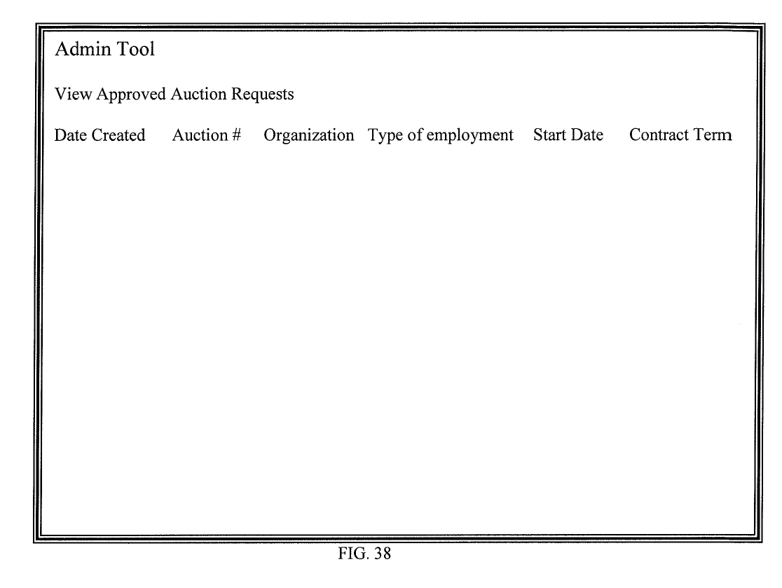

FIG. 37 allows an administrator of auction website 190 to view pending auction requests. FIG. 38 allows an administrator of auction website 190 to view approved auction requests. An approved auction means that a permanent auction has completed all prerequisite screening and is ready to begin the auction process. For a temporary placement, an approved auction means that the entity hosting the website 190 has confirmed a resource from a staffing company partner that they can fill the order.

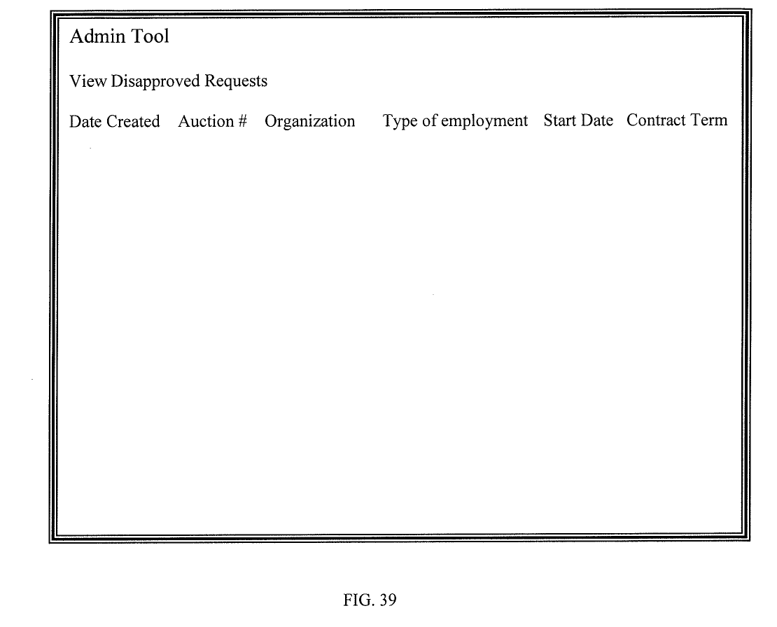

FIG. 39 allows an administrator of auction website 190 to view disapproved auction requests. A disapproved permanent auction means that the candidate's screening revealed that the candidate is not acceptable quality according to the entity hosting the auction website 190. For a temporary placement, an auction is disapproved if the entity hosting the auction web site 190 cannot procure the staffing resource.

The subject matter described herein may be embodied in systems, apparatus, methods, and/or articles depending on the desired configuration. In particular, various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, applications, components, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein do not require the particular order shown, or sequential order, to achieve desirable results. Other embodiments may be within the scope of the following claims.

What is claimed:

1. An article comprising a machine-readable medium embodying instructions that when performed by one or more machines result in operations comprising:
initiating a first auction, by a first user interface associated with a provider of health care;
initiating a second auction, by a second user interface associated with an employer, when the employer seeks a placement of the provider, the second auction enabling bidding on the provider; and
making, by the second user interface, one or more bids on at least one of the first auction and the second auction.

2. The article of claim 1, wherein initiating the second auction further comprises:
initiating the second auction, when the employer seeks a temporary placement of the provider.

3. The article of claim 1, wherein initiating the second auction further comprises:
initiating the first auction, when profile information representative of one or more parameters of employment of the provider is received, the first auction enabling bidding on the provider.

4. The article of claim 3 further comprising:
providing the profile information including one or more of the following: a geographic location, a specialty, a clinical setting, an experience level, and an indication of whether the placement is a permanent placement, a temporary placement, or a traveling placement.

5. The article of claim 1 further comprising:
providing a minimum salary and a start date of employment, the minimum salary representing a floor bid for at least one of the first auction and the second auction.

6. A computer-implemented method comprising:
initiating a first auction, by a first user interface associated with a provider of health care;
initiating a second auction, by a second user interface associated with an employer, when the employer seeks a temporary placement of the provider, the second auction enabling bidding on the provider; and
making, by the second user interface, one or more bids on at least one of the first auction and the second auction.

7. The computer-implemented method of claim 6, wherein initiating the second auction further comprises:
initiating the second auction, when the employer seeks a temporary placement of the provider.

8. The computer-implemented method of claim 6, wherein initiating the second auction further comprises:
initiating the first auction, when profile information representative of one or more parameters of employment of the provider is received, the first auction enabling bidding on the provider.

9. The computer-implemented method of claim 8 further comprising:
providing the profile information including one or more of the following: a geographic location, a specialty, a clinical setting, an experience level, and an indication of whether the placement is a permanent placement, a temporary placement, or a traveling placement.

10. The computer-implemented method of claim 7 further comprising:
providing a minimum salary and a start date of employment, the minimum salary representing a floor bid for at least one of the first auction and the second auction.

11. A system comprising:
a processor; and
a memory, wherein the processor and the memory are configured to perform a method comprising:
initiating a first auction, by a first user interface associated with a provider of health care, when profile information representative of one or more parameters of employment of the provider is received, the first auction enabling bidding on the provider;
initiating a second auction, by a second user interface associated with an employer, when the employer seeks a placement of the provider, the second auction enabling bidding on the provider; and
making, by the second user interface, one or more bids on at least one of the first auction and the second auction.

12. The system of claim 11, wherein initiating the second auction further comprises:
initiating the second auction, when the employer seeks a temporary placement of the provider.

13. The system of claim 11 further comprising:
receiving one or more bids from at least one of the first and second auctions; and
selecting at least one of the one or more bids.

14. The system of claim 11 further comprising:
providing, at a website accessible by at least one of the first interface and the second user interface, at least one of a message board and a marketplace.

15. The system of claim 11 further comprising:
providing a minimum salary and a start date of employment, the minimum salary representing a floor bid for at least one of the first auction and the second auction.
